(19) United States
(12) Patent Application Publication
(10) Pub. No.: US 2006/0211426 A1
(43) Pub. Date: Sep. 21, 2006

(54) Method for allocating radio communication resources and network unit associated with a multi-carrier radio communication system

(76) Inventors: Elena Costa, Munich (DE); Egon Schulz, Munich (DE); Peter Trifonov, St Petersburg (RU); Martin Weckerle, Ulm (DE)

Correspondence Address: STAAS & HALSEY LLP, SUITE 700, 1201 NEW YORK AVENUE, N.W., WASHINGTON, DC, 20005, US

(21) Appl. No.: 10/568,946

(22) PCT Filed: Jul. 21, 2004
(86) PCT No.: PCT/EP04/51563

§ 371 Date: Feb. 21, 2006

(30) Foreign Application Priority Data
Aug. 19, 2003 (DE) 103380531

(51) Int. Cl. H04Q 7/20

(52) U.S. Cl. 455/450; 455/509

(57) ABSTRACT

Radio communication resources are allocated in a cellular radio communication system having a plurality of user stations and network units by subdividing a frequency band that is sub-divided into a plurality of sub-carriers used for communication purposes. In several radio cells, one or more network units sub-divides(s) the frequency band into a number of sub-bands having one or more respective sub-carriers, sub-divide(s) the user stations into a number of groups and allocate(s) a sub-band for communication purposes to each group. The number of sub-bands differs for at least two radio cells.

### CROSS REFERENCE TO RELATED APPLICATIONS

This application is based on and hereby claims priority to German Application No. 103 380 51.1 filed on Aug. 19, 2003, the contents of which are hereby incorporated by reference.

### BACKGROUND OF THE INVENTION

1. Field of the Invention

The invention relates to a method for allocating radio communication resources in a cellular radio communication system having a plurality of user stations and network units.

Furthermore the invention relates to a network unit for a radio cell of a cellular radio communication system having a plurality of user stations, and to a computer program product for a network unit for a radio cell of a cellular radio communication system having a plurality of user stations.

2. Description of the Related Art

In radio communication systems information (for example speech, picture information, video information, SMS (Short Message Service) or other data) is transmitted with the aid of electromagnetic waves over a radio interface between the sending and the receiving radio station. The electromagnetic waves in such systems are radiated using carrier frequencies which lie within the frequency range provided for the relevant system. A radio communication system in this case includes user stations, e.g. mobile stations, base stations, e.g. node Bs, or other radio access devices, as well as further network units where required. Cellular radio communication systems consist of a plurality of individual radio cells, which are each serviced for example by a base station or a radio access point of a radio-based local area network (WLAN, Wireless Local Area Network).

For third-generation mobile radio systems, such as UMTS (Universal Mobile Telecommunication System), carrier frequencies in the range of around 2000 MHz are provided. These systems and others are developed with the aim of providing a greater range of services and flexible administration of the radio communication resources, which are generally in short supply in radio communication systems. The flexible allocation of the radio communication resources is designed to enable user stations to send and receive large volumes of data at high speed if required.

Access by user stations to the shared radio communication resources, such as for example time space, frequency, code, is regulated in radio communication systems by multiple access (MA) methods.

With Time Division Multiple Access (TDMA) the radio resource of time is divided up into time slots, with one or more cyclically repeated time slot(s) being allocated to the user stations. The radio resource time is separated by TDMA on a station-specific basis. With Frequency Division Multiple Access (FDMA) frequency bands are subdivided into narrowband areas, with one or more of the narrowband areas being allocated to the user stations. The radio resource frequency is separated by FDMA on a station-specific basis. Many radio communication systems use a combination of TDMA and FDMA, so that narrow frequency bands are subdivided into time slots.

With Code Division Multiple Access (CDMA) the information bits to be transferred are multiplied by spread codes of a number of chips. The spread codes used by the various user stations within a radio cell of a base station are mutually orthogonal or essentially orthogonal to each other in each case, which enables a recipient to detect the signal intended for it and to suppress other signals. The radio resource is separated by CDMA in the form of a set of orthogonal codes on a station-specific basis.

To guarantee that data is transmitted as efficiently as possible an available frequency band can be divided up into a number of sub-carriers (multi-carrier method). The basic idea underlying multi-carrier systems is to translate the initial problem of the transmission of a broadband signal into the transmission of a quantity of narrowband signals. One of the advantages of this is that the complexity required at the receiver can be reduced. Furthermore the division of the available bandwidth into a number of narrowband sub-carriers allows a far higher granularity of data transmission as regards the distribution of the data to be transmitted on the different sub-carriers i.e. the radio resources can be distributed with far greater freedom between the data to be transmitted or between the receivers.

With OFDM (Orthogonal Frequency Division Multiplexing) almost rectangular time pulse shapes are used on the sub-carriers. The frequency spacing of the sub-carriers is selected so that in the frequency space for that frequency at which the signal of a sub-carrier is evaluated, the signals of the other sub-carriers exhibit a zero crossing. The sub-carriers are thus orthogonal to each other. A spectral overlapping of the sub-carriers and as a result a high packing density of the sub-carriers is allowed, since the orthogonality ensures that the individual sub-carriers can be distinguished. The result is thus a high spectral efficiency. The mostly very small spacing between the sub-carriers is designed to guarantee that transmission on the individual sub-carriers is generally not frequency-selective. This simplifies signal equalization at the receiver. The data symbols transferred during a unit of time on the orthogonal sub-carriers are referred to as OFDM symbols.

Multi Carrier Code Division Multiple Access (MC-CDMA, Multi Carrier-CDMA) involves a combination of CDMA and OFDM, with the spreading of a symbol being undertaken in the frequency space, i.e. on all sub-carriers. The chips of the spread symbols of different user stations are transmitted simultaneously by orthogonal codes. The radio communication resources, such as frequency and a set of orthogonal codes are separated on a station-specific basis by MC-CDMA.

With multi-carrier methods it is possible to temporarily allocate to a user station the entire available frequency bandwidth, i.e. all sub-carriers, i.e. make it available for communication. Another possibility is to group the sub-carriers into sub-bands, with the sub-bands especially containing the same number of sub-carriers. In addition to the existence of the plurality of sub-carriers, this introduces a further FDMA component, regarding the existence of a plurality of sub-bands. The user stations can then be divided up into groups, with each group being allocated one of the sub-bands for communication purposes. The introduction of the additional FDMA component in multi-carrier systems in the form of sub-bands has the advantage that, by contrast with the allocation of the entire bandwidth to one user station, a higher granularity and thus a greater flexibility can be achieved in the allocation of radio communication resources. It should be noted however that the type of subdivision of the available frequency band into sub-bands effects the efficiency of the allocation of radio communication resources to the user stations.

### SUMMARY OF THE INVENTION

An object of the invention is to demonstrate a method and a network unit for effective allocation of radio resources in a cellular multi-carrier radio communication system. Furthermore a computer program product for supporting the method is to be presented.

The method is used for allocating radio communication resources in a cellular radio communication system having a plurality of user stations and network units. In the radio communication system a frequency band divided up into a plurality of sub-carriers is used for communication purposes. In a number of radio cells the frequency band is divided up by one or more network units into a number of sub-bands, each including one or more sub-carriers, user stations are divided up into a number of groups and each group is allocated a sub-band for communication. In accordance with the invention the number of sub-bands differs for at least two radio cells.

In the radio communication system a wide frequency band is used which is divided up into sub-carriers, with further frequency bands also being able to be used in addition to this frequency band. The division of the frequency bands into the sub-carriers is considered as predetermined within the framework of the invention. The sub-carriers involved can especially be sub-carriers of the same width, meaning equidistant sub-carriers, which are used for example for an OFDM transmission. The network unit or the network units which undertake the division into sub-bands, division into groups and allocation of sub-bands to groups can be one unit sharing a number of radio cells or a network unit responsible only for an individual radio cell.

The frequency band is divided up into sub-bands, with each sub-band containing at least one sub-carrier, in a special case all sub-bands contain at least two sub-carriers. The different sub-bands of a radio cell can contain a differing number of sub-carriers from each other, in accordance with a special case all sub-bands of a radio cell have the same frequency width. Furthermore user stations, especially only those user stations which have reported that they need radio resources, are divided into groups. Preferably the number of groups corresponds to the number of sub-bands of a radio cell. It is possible for each sub-carrier to only belong to one sub-band and for each user station only to belong to one group. Advantageously each sub-carrier only belongs to one sub-band while some user stations or all user stations are assigned to more than one group.

In accordance with an aspect of the invention the number of sub-bands used is radio-cell-specific for least some radio cells of the radio communication system. It is thus possible for adjacent radio cells to use a same or a different number of sub-bands. Thus in the radio communication system considered there exists a location dependence of the division of the frequency bands into sub-bands.

In accordance with an embodiment of the invention, in the radio cell of the at least two radio cells, the number of sub-bands of the network unit or of the network units is determined as a function of transmission conditions in the radio cell concerned. The number of sub-bands used in radio cells is thus dependent on parameters which influence the transmission conditions in the relevant radio cell, such as for example an architecture in the radio cell or other factors which have effects on the multi-path propagation of radio signals.

The transmission conditions can in particular relate to transmission capacities of the sub-carriers in the relevant radio cell. A transmission capacity specifies a bit rate per bandwidth. It can for example be determined by measuring a signal-to-noise ratio or a channel transfer factor, with the determination of the channel transfer factor including the measurement of a signal-to-noise ratio and subsequent use of Shannon's formula.

The transmission conditions can be determined by at least one user station and/or a network unit by measuring signal-to-noise ratios, especially of sub-carrier-specific or signal-to-noise ratios per sub-carrier.

In a further development of the invention, in each radio cell of the least two radio cells, the number of sub-bands is determined by the network unit or network units taking into account the data transmission made possible by the subsequent division of the frequency band into sub-bands and division of user stations into groups and allocation of sub-bands to groups. The data transmission made possible is understood in this case as the data transmission which on average or under normal circumstances can be realized with the division into sub-bands, division into groups and allocation of sub-bands to groups undertaken. Thus the determination of the number of sub-bands is for example influenced by the transmission quality which is to be experienced in the relevant radio cell after allocation of radio resources has been completed.

Advantageously the division into sub-bands and division into groups and the allocation of sub-bands to groups is undertaken in at least one radio cell using a method, in which to increase the transmission capacity in the relevant radio cell, starting from the transmission capacity of a first constellation of division into sub-bands, division into groups and allocation of sub-bands to groups, the transmission capacity of a modified constellation of division into sub-bands, division into groups and allocation of sub-bands to groups is calculated. This makes it possible to compare transmission capacities of different constellations so that, by selecting constellations with high transmission capacity, a constellation which uses the radio resources as efficiently as possible can be determined and the radio resources can be allocated to the users in accordance with the constellation determined. For the constellations, this means that with the first and the modified constellation, these do not have to be real constellations in accordance with which the user stations were allocated radio resources, but rather these can involve fictitious constellations which are only used for calculation of the transmission capacities under the condition in which the radio resources would be allocated to the user stations in accordance with the fictitious constellation.

The modified constellation can be formed from the first constellation by swapping at least one user station with a user station of another group, with the division into sub-bands and the allocation of sub-bands to groups remaining the same and/or by swapping at least one sub-carrier of the sub-band with the sub-carrier of another sub-band with the division into groups and the allocation of sub-bands to groups remaining the same. This swapping algorithm in particular makes it possible for precisely two user stations from different groups and two sub-carriers from different sub-bands to be swapped in each case and thus a modified constellation to be formed.

In accordance with an embodiment of the invention in each radio cell of the at least two radio cells the number of sub-bands of the network unit or network units is determined so that with the methods for increasing the transmission capacity a predetermined increase in the transmission capacity in the relevant radio cell and/or a predetermined transmission capacity in the relevant radio cell can be achieved. In this case for example an increase in the transmission capacity and/or the transmission capacity which is the same for all radio cells can be predetermined in the relevant radio cell. Accessibility is taken to mean an average accessibility or accessibility under normal circumstances.

In a development of the invention, after allocation of sub-bands to groups in the communication of user stations, data bits are spread using codes on some or all sub-carriers of the respective sub-band allocated so that an MC-CDMA transmission method is involved here.

Signals which are transmitted on at least partly the same sub-carriers after the allocation of sub-bands to groups for the communication between user stations of a group can be able to be differentiated from each other through their spatial propagation. In this case an MC-SDMA transmission method is involved. A combination of an MC-CDMA method with an MC-SDMA method is also especially possible.

The inventive network unit is suitable for a radio cell of a cellular radio communication system having a plurality of user stations, with a frequency band subdivided into a plurality of sub-carriers being used in the radio communication system for communication purposes. The network unit is able to determine a number of sub-bands depending on transmission conditions in the radio cell as well as dividing up the frequency band into at the number of sub-bands each featuring one or more sub-carriers, including dividing up the user stations into a number of groups and allocating the sub-bands to a group for communication in each case.

The inventive network unit is especially suitable for executing the inventive method described above, with this also applying to the embodiments and developments of the invention. The inventive network unit can be an element of a radio communication system which, in addition to the network unit, includes a plurality of user stations and where necessary further network units.

The computer program product is suitable for a network unit for a radio cell of a cellular radio communication system having a plurality of user stations, with a frequency band divided up into a plurality of sub-carriers being used in the radio communication system for communication purposes. The computer program product is used for determining a number of sub-bands depending on transmission conditions in the radio cell, for dividing up the frequency band into the number of sub-bands each containing one or more sub-carriers, for dividing up user stations into a number of groups and for allocating the sub-bands to a group for communication in each case.

The inventive computer program can especially be stored in a network unit of the radio communication system and executed there, or can also be downloaded by the network unit from another unit. The computer program product in the context of the present invention, as well as the actual computer program (with its technical effect extending beyond the normal physical interaction between program and processor unit) can be taken to mean especially the recording medium for the computer program, a collection of files, a configured processor unit, but also for example a memory unit or a server on which the file or files belonging to the computer program are stored.

### BRIEF DESCRIPTION OF THE DRAWINGS

These and other objects and advantages of the present invention will become more apparent and more readily appreciated from the following description of an exemplary embodiment, taken in conjunction with the accompanying drawings of which:

FIG. 1: is a block diagram of a section of a cellular radio communication system,

FIG. 2: is a graph showing a division of the frequency band into sub-carriers and sub-bands,

FIG. 3: is a graph of frequency-dependent capacities,

FIG. 4: is a schematic diagram of a base station in accordance with invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

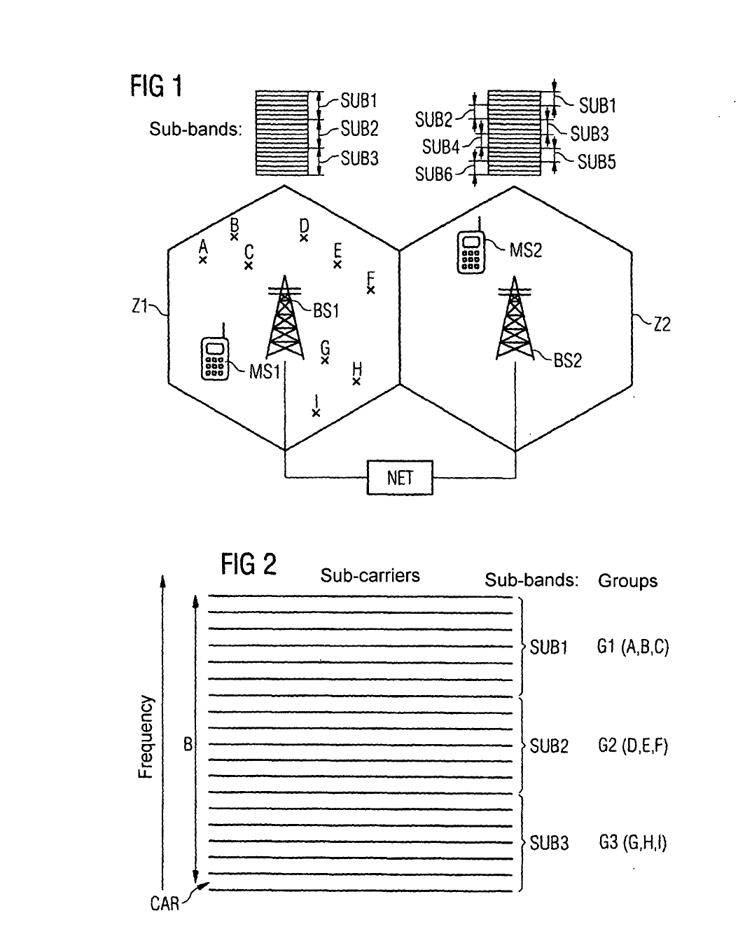

FIG. 1 depicts a cellular radio communication system, showing sections of the two radios cells Z1 and Z2 with their relevant base stations BS1 and BS2. The two base stations BS1 and BS2 are connected to further network units NET and to a core network (not shown), which in its turn can feature connections to other communication and data networks. For reasons of simplicity further radio cells are not shown. The radio communication system can for example be a full-coverage radio communication system of the third generation or also a not necessarily full-coverage interconnected local area radio communication systems (WLAN, Wireless Local Area Network). The radio communication system can for example be embodied in accordance with the standard IEEE 802.11 or other IEEE 802.x standards. With local area networks the base stations BS1 and BS2 correspond to the radio access points (AP) of the WLANs. Another element of the radio communication system are user stations, such as laptops, PDAs (Personal Digital Assistants), cell phones or smart phones for example. In FIG. 1 the mobile station MS1 is located in the radio cell Z1 and the mobile station MS2 in the radio cell Z2. Also located in the radio cell Z1 are the mobile stations A, B, C, D, E, F, G, H and I.

The mobile stations MS1, MS2, A, B, C, D, E, F, G, H and I of the radio communication system communicate via radio with the base stations BS1 and BS2 of their respective radio cell Z1 and Z2 using a frequency band. Such a frequency band B is shown in FIG. 2. The frequency is plotted In the vertical direction in this case. The frequency band B is divided up into a plurality of equidistant, same-width sub-carriers CAR, with these being able to be OFDM bands. With a frequency width of the frequency band B of 20 MHz a possible division would be into 512 OFDM sub-carriers CAR.

If a mobile station communicates with a base station, the entire frequency band B is not used for this purpose however. Instead the frequency B is divided up into a number of sub-bands, for the radio cell Z1 e.g. as shown in FIG. 1 at the top and in FIG. 2, into the three sub-bands SUB1, SUB2 and SUB3, which each contain the same number of sub-carriers CAR. The sub-bands SUB1, SUB2 and SUB3 of the radio cell Z1 contain six sub-carriers CAR in each case. Whereas in FIG. 2 the sub-carriers CAR of the individual sub-bands SUB1, SUB2 and SUB3 are adjacent, as a rule it is better for reasons of frequency diversity for the sub-carriers CAR of the sub-bands SUB1, SUB2 and SUB3 to be spaced from each other. In the example shown in FIG. 2 the sub-band SUB1 could for instance be made up of the first, the seventh and the thirteenth sub-carrier or of another sequence of non-adjacent sub-carriers. Basically any division of the sub-carriers into sub-bands is conceivable, provided the number of the sub-carriers per sub-band is the same for all sub-bands.

The number of sub-bands into which the frequency band in the various radio cells is divided differs from cell to cell In the upper part of FIG. 1 it is shown that in the radio cell Z1 the three sub-bands SUB1, SUB2 and SUB3 are used, whereas in the radio cell Z2 there is a division of the overall frequency band into the six sub-bands SUB1, SUB2, SUB3, SUB4, SUB5 and SUB6. In relation to the overall radio communication system it is not necessary for the numbers of sub-bands of all radio cells to differ from one another. Instead adjacent radio cells can be present of which the number of sub-bands differs and adjacent radio cells of which the number of sub-bands is the same.

The user stations of a radio cell which currently require radio communication resources for communication are divided up by the relevant base station BS1 or BS2 or by another network unit NET into groups, with each group being allocated a sub-band for communication purposes in FIG. 2 a group G1 has been allocated the sub-band SUB1, a group G2 the sub-band G2 and a group G3 the sub-band G3. The group G1 contains the mobile stations A, B and C, the group G2 the mobile stations D, E and F, and the group G3 the mobile stations G, H, I. It is however not generally necessary for all groups to contain the same number of mobile stations.

The mobile stations of each group communicate exclusively on the sub-carriers CAR of the relevant sub-band allocated to the group. This means that the individual sub-bands can be seen as individual MC-MA (Multi carrier-Multi Access) systems. To be able to distinguish between signals sent simultaneously on the same sub-carriers, the CDMA (Code Division Multiple Access) or the SDMA (Space Division Multiple Access) method can be used.

For use of the CDMA method data bits are spread in the frequency space, i.e. over the individual sub-carriers CAR. The mobile station A can for example use a code of length six, so that at a point in time a data bit can be sent or received by the mobile station A of which the chips are sent or received on the six sub-carriers CAR of the sub-band SUB1. If two codes of length three are used by mobile station A, a simultaneous transmission of two data bits on the six sub-carriers CAR of the sub-band SUB1 is possible. The codes which are used by the mobile stations within a group must in this case be orthogonal or at least approximately orthogonal to one another, to enable them to distinguish the different data bits. The codes to be used are allocated to the mobile stations by the base station of their radio cell for a specific period. A mobile station can either use all sub-carriers CAR of the sub-band of its group or also only some of these sub-carriers.

As an alternative to the use of spread codes in accordance with the CDMA method the distinction of the signals sent simultaneously from or to different mobile stations on the same sub-carriers CAR is also possible through local separation of the signals in accordance with the SDMA method. In this case a directed propagation of the signals is undertaken so that different signals generate no interference or negligible mutual interference at the location of the relevant receiver.

In addition to the CDMA or SDMA methods a division of the time radio resource into timeslots is sensible. Thus the mobile station A for example can be assigned a code of length three for a first time slot, a code of length six for a second time slot and to code of length three for a third time slot, with other timeslots able to be located between the first and the second, as well as between the second and the third timeslots within which no codes are allocated to the mobile station A.

The transmission quality or the quality of a channel of a sub-carrier CAR differs as a rule from mobile station to mobile station Thus it is possible that the mobile station A experiences a lower signal-to-noise ratio on a specific sub-carrier CAR of the sub-band SUB1 than the mobile station G on the same sub-carrier. This fact should be taken into account when a radio resources are allocated to the mobile stations. Also in the case in which an allocation of radio resources has been undertaken once which takes account of the different channel qualities experienced by the mobile stations, this allocation must be modified if a new mobile station requests radio resources within the radio cell or a mobile station which previously belonged to a group leaves the radio cell.

Thus an intelligent, adaptive method is used for efficiently allocating the radio communication resources to the mobile stations. The initial assumption is made here that the channel quality of each individual channel, i.e. of all sub-carriers CAR, between each mobile station of its radio cell which has requested radio communication resources, and the base station is known to the base station. This can be done for example by the mobile stations establishing, on the basis of a pilot signal sent out by the base station, the signal-to-noise ratios or channel transfer factors of each individual sub-carrier CAR and transmitting the results to the base station. To determine the variables signal-to-noise ratio or channel transfer factor for just a part of the sub-carriers CAR the base station can perform extrapolation or interpolation calculations to calculate the variables for the remaining sub-carriers CAR. Alternatively it is advantageous for the base station to execute the measurements or calculations on the basis of pilot signals sent out by the mobile stations on some of the sub-carriers or on all sub-carriers CAR.

The decision about whether the base station or the mobile stations perform the channel estimation on the sub-carriers CAR especially depends on whether for the data transmission which takes place subsequent to the resource allocation, this involves a transmission in the uplink direction (from the base station to a mobile station) or in the downlink correction (from a mobile station to the base station). For a transmission in the downlink direction the best choice is to establish the channel in the downlink direction so that in this case the mobile station should be establishing the channel quality of the sub-carriers CAR. In the reverse case, i.e. for transmission in the uplink direction, it makes sense for the base station to perform the channel estimation.

It should be noted that the channel estimation involves considerable effort for the mobile station Furthermore where the channel quality is determined by the mobile station the result must be transmitted to the base station, which occupies radio resources. Where a TDD (Time Division Duplex) method is used it is thus also possible for a future data transmission in the downlink direction for the base station to perform the channel estimation. In this case the reciprocity of the transmission channels in the uplink and downlink direction which is generally provided in TDD systems is utilized. However one condition is that there is only a short period of time between the channel estimation by the base station and the data transmission, so that the channel cannot change greatly during this period.

Because of the knowledge of the transmission channels for all sub-carriers CAR and all mobile stations A, B, C, D, E, F, G, H, I interested in radio resources, the base station BS1 or a suitable the network unit connected to it is able to perform an especially favorable allocation of the radio resources. In this case the entire transmission capacity in the radio cell Z1 for a random constellation consisting of
a division of the frequency band B into sub-bands SUB1, SUB2 and SUB3,
a division of the mobile stations A, B, C, D, E, F, G, H and I into groups G1, G2 and G3 and
an allocation of the sub-bands SUB1, SUB2 and SUB3 to the groups G1, G2 and G3 is calculated.

It should be noted in this case that the division of the frequency band B is predetermined in a fixed manner in the sub-carriers CAR. The reason for this is that, for a predetermined transmission method such as OFDM for example, the width or spacings of the individual sub-carriers CAR should not simply assume any values. Furthermore the number of the sub-bands within the radio cell is predetermined at this point in time i.e. when a suitable constellation of sub-band division, group division and assignment of sub-bands to groups is determined. Thus the base station BS1, in allocating the radio resources, starts from the assumption that the frequency band B is subdivided into 18 sub-carriers CAR, and that the frequency band B has to be divided into three sub-bands of equal width.

The transmission capacity specifies the data rate for each bandwidth used for this. It can be derived for example using Shannon's formula from the signal-to-noise ratio or from the channel transfer factor in conjunction with the noise level. The overall transmission capacity in a radio cell is given by the total of the transmission capacities for the individual mobile stations. The transmission capacity for a mobile station is given by the total of the individual transmission capacities which was determined for the mobile station on the sub-carriers of the sub-band allocated to its group.

At the beginning base station BS1 calculates the transmission capacity of the constellation shown in FIG. 2 for example. After this the mobile station A is swapped with each mobile station D, E, F, G, H, I of another group, without in this case however altering the composition of the sub-bands SUB1, SUB2 and SUB3 of sub-carriers CAR or the allocation of the sub-bands to the groups. For each constellation resulting from the swap the transmission capacity in the radio cell is calculated. After each calculation of the transmission capacity in the radio cell the swap is reversed again, so that in each case only the influence of a single swap on the transmission capacity in the radio cell is determined in each case. Thereafter each other mobile station is similarly swapped with each other mobile station of another group and the transmission capacity in the radio cell for this constellation is calculated. That constellation which has produced the greatest transmission capacity in the radio cell for the fictitious swapping of the mobile stations is the start point for the next step. This involves a constellation in which, compared to that shown in FIG. 2, precisely two mobile stations of different groups are swapped. One such possible constellation would for example be the case in which the group G1 consists of the mobile stations F, B, C, the group G2 of the mobile stations D, E, A, and the group G3 of the mobile stations G, H, I.

Each swap would occur in this case not in the manner that in accordance with the resulting constellation radio communication resources were allocated to the mobile stations. Instead only the transmission capacity which would be available in the radio cell after a swap is calculated.

Starting from the new constellation, the first sub-carrier CAR of the sub-band SUB1 is now swapped with each sub-carrier CAR of each of the other sub-bands SUB2 and SUB3 and the transmission capacity in the radio cell recalculated. This operation is performed in a similar fashion for each other sub-carrier CAR. That swap which has led to the greatest increase in the transmission capacity in the radio cell is retained. As a result a constellation is thus available within which, compared to the constellation shown in FIG. 2, precisely two mobile stations and precisely two sub-carriers CAR are swapped.

Subsequently the swapping of mobile stations described above, followed by a further swapping of sub-carriers, etc. can be performed.

The two steps described, swapping of mobile stations between different groups and swapping of sub-carriers between different sub-bands, can be performed as many times as required to achieve a specific transmission capacity in the radio cell or a specific increase of the transmission capacity in the radio cell compared to the initial constellation. It is also possible to perform the steps until such time as a counter, e.g. a clock or a counter for the number of steps performed, has reached a specific value. After the last constellation has been determined, the radio communication resources will be assigned by notifying to the mobile stations the sub-band composition, group composition and assignment of the sub-bands to groups to the mobile stations.

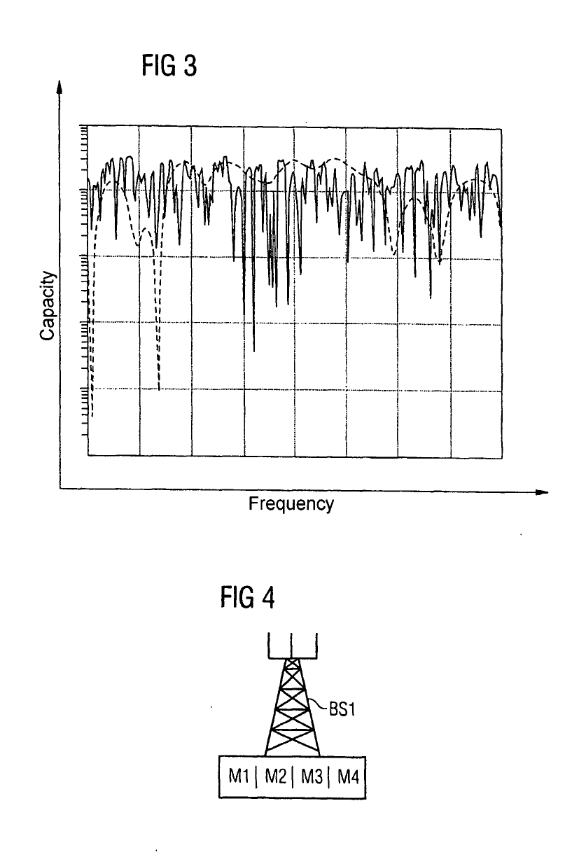

In the method described above for determination of a suitable sub-band division, group division and assignment of sub-bands to groups the results of the channel estimation are examined for all sub-carriers for each mobile station. These channel estimation results are dependent on the location of the radio cell. Thus for example, in relation to the delay to radio signals through delay spread for an outdoor radio cell a value of 5 μm is possible, whereas for an indoor-radio cell a value of 0.8 μm can be expected. FIG. 3 shows a graph which contains the transmission capacities for individual sub-carriers. The frequency is plotted to the right and the capacity at the top. In this case a frequency band divided up into 512 sub-carriers has been subdivided into 8 sub-bands, with the limits of the sub-bands being specified by vertical lines. The rapidly oscillating line relates to the capacity of sub-carriers of an outdoor cell whereas the flatter curve represents the capacity of sub-carriers of an indoor cell. It is evident that the variance of the outdoor curve is greater than that of the indoor curve. However it can also be seen that the average value of the capacities across all sub-carriers of a sub-band for the outdoor curve is approximately the same for all sub-bands. On the other hand the value of the capacities of the sub-carrier hardly varies for the indoor curve for the different sub-carriers of each sub-band, while the average value of the capacities across all sub-carriers of a sub-band varies greatly from sub-band to sub-band.

FIG. 3 shows the case in which all sub-carriers of each of the eight sub-bands are adjacent. The information relating to the characteristics of the capacity curves for indoor and outdoor radio cells however also applies to the case in which the sub-carriers of the sub-bands are not exclusively adjacent sub-carriers.

As a result of these different variants of the two capacity curves, the swapping procedure described above achieves a different capacity gain for different radio cells or for radio cells in areas with different radio propagation. It can be shown that for the division of the frequency band into sub-carriers and sub-bands shown in FIG. 3, a greater capacity gain can be achieved for the indoor radio cell than for the outdoor radio cell. This can be explained by a sampling rate of the capacity curves of the outdoor radio cell being too low in the swapping method. Furthermore it can be shown that the capacity gain for the outdoor radio cell can be increased by the number of the sub-carriers per sub-band being reduced, i.e. by using more than eight sub-bands in the outdoor-radio cell.

in accordance with the invention the number of sub-bands to be used in the radio cell is determined on the basis of the transmission conditions within a radio cell. To realistically estimate the transmission conditions, the average of a plurality of channel estimation results of different mobile stations of a radio cell is formed. The transmission conditions for establishing a suitable number of sub-bands should always be determined if major changes occur in the radio cell. Examples of such changes are repositioning of walls or large items furniture in indoor radio cells or shadowing effects caused by leaves growing on trees in outdoor radio cells. As a rule however such changes occur very rarely, so that, once determined, the number of sub-bands to be used can be retained for a long time.

After the determination of the transmission conditions in the relevant radio cell the size of the average capacity gain achieved with the swapping procedure described above for different numbers of sub-bands used is calculated. An expressive variable for this estimation is the Fourier-transformed correlation of the capacities of the sub-carriers. With a predetermined capacity gain through the swapping method or predetermined capacity after the swapping method the minimum number of sub-bands needed for this gain can be determined. The predetermined capacity gain or the predetermine capacity can be uniform for all radio cells of the radio communication system, so that a homogeneity of transmission conditions can be implemented beyond radio cell boundaries.

In relation to the radio communication system the procedure described then has the effect that the number of sub-bands used is location-dependent or radio cell-dependent. Thus, as depicted schematically in the upper part of FIG. 1, three sub-bands SUB1, SUB2 and SUB3 are used in the radio cell Z1 and six sub-bands SUB1, SUB2, SUB3, SUB4, SUB5 and SUB6 in the radio cell Z2. The radio cell Z1 can for example be an indoor-radio cell and the radio cell Z2 an outdoor radio cell.

If the mobile station MS1 moves from the radio cell Z1 to the radio cell Z2 (handover), its is assigned in the radio cell Z2 to a new group and thus to a sub-band. This means that a maximum of three sub-carriers are now available to the mobile station MS1, whereas in the radio cell Z1 a maximum of six sub-carriers were available to it for communication. This reduction in the maximum allocated sub-carriers can be compensated for by the mobile station MS1 being allocated double the number of other radio communication resources, such as time slots, codes or space directions for example. Another option is to assign mobile stations to more than one group.

FIG. 4 shows an inventive base station BS1 for executing the procedural steps described. This features means M1 for defining a number of sub-bands depending on transmission conditions in its radio cell. The transmission conditions can in this case either be determined by mobile stations of its radio cell and communicated to the base station BS1 or the transmission conditions are determined in the base station BS1 using suitable means. Advantageously means for permanent or semipermanent storage of the transmission conditions are also present in the base station BS1. The specific number of sub-bands is then used by the means M2 to divide up the frequency band into a number of sub-bands. For allocating radio communication resources to mobile stations there are also means M3 for dividing up the mobile stations interested in radio communication resources into groups. Finally the means M4 are used for allocating the sub-bands to a group for communication in each case.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-12. (canceled)

13. A method for allocating radio communication resources in radio cells of a cellular radio communication system having a plurality of user stations and network units, comprising:
dividing a frequency band into a plurality of sub-carriers used in the radio communication system for communication purposes, by dividing the frequency band into a number of sub-bands, each sub-band including at least one sub-carrier, so that the number of the sub-bands is different in at least two of the radio cells;
dividing the user stations into a number of groups; and
allocating each group of the user stations to one of the sub-bands for communication.

14. A method in accordance with claim 13, further comprising determining the number of sub-bands depending on transmission conditions in each of the at least two radio cells.

15. A method in accordance with claim 14, wherein the transmission conditions are transmission capacities of the at least one sub-carrier in each of the radio cells.

16. A method in accordance with claim 15, further comprising determining the transmission conditions by at least one of at least one user station and at least one network unit based on measured signal-to-noise ratios.

17. A method in accordance with claim 13, wherein said determining of the number of sub-bands for each of the at least two radio cells takes into consideration data transmission made possible subsequently by said dividing of the frequency band into sub-bands, said dividing of the user stations into groups and said allocating of each group to the one of the sub-bands.

18. A method in accordance with claim 13, wherein said dividing into the sub-bands and the groups and said allocating of each group to the one of the sub-bands comprises in order to increase transmission capacity:
starting from the transmission capacity of an initial constellation of said dividing into the sub-bands and the groups and said allocating of each group to the one of the sub-bands; and
calculating the transmission capacity of a modified constellation of said dividing into the sub-bands and the groups and said allocating of each group to the one of the sub-bands.

19. A method in accordance with claim 18, further comprising forming the modified constellation from the initial constellation by at least one of
swapping at least one user station of a first group with at least one other user station of a second group while said dividing into the sub-bands said allocating of each group to the one of the sub-bands remains unchanged; and
swapping at least one sub-carrier of a first sub-band with at least one other sub-carrier of a second sub-band while said dividing into the groups and said allocating of each group to the one of the sub-bands remains unchanged.

20. A method in accordance with claim 18, wherein said determining of the number of sub-bands for each of the at least two radio cells achieves at least one of a predetermined increase in the transmission capacity and a predetermined transmission capacity in the at least two radio cells.

21. A method in accordance with claim 13, further comprising, after said allocating of each group to the one of the sub-bands, spreading data using codes on at least some sub-carriers of the one of the sub-bands.

22. A method in accordance with claim 13, wherein signals transmitted after said allocating of each group to the one of the sub-bands on at least partly same sub-carriers, can be distinguished from each other by spatial propagation thereof.

23. A network unit for a radio cell of a cellular radio communication system having a plurality of user stations, and a frequency band divided into a plurality of sub-carriers being used in the radio communication system for communication, said network unit comprising:
means for defining a number of sub-bands depending on transmission conditions in the radio cell;
means for dividing the frequency band into the number of sub-bands each having at least one sub-carrier;
means for dividing user stations into a number of groups; and
means for allocating each group to one of the sub-bands.

24. A computer readable medium storing a program that when executed controls a network unit for a radio cell of a cellular radio communication system, having a plurality of user stations, to perform a method comprising:
defining a number of sub-bands depending on transmission conditions in the radio cell;
dividing the frequency band into the number of sub-bands each having at least one sub-carrier,
dividing user stations into a number of groups; and
allocating each group to one of the sub-bands.
